(19) United States
(12) Patent Application Publication
(10) Pub. No.: US 2018/0330312 A1
(43) Pub. Date: Nov. 15, 2018

(54) System, method and apparatus to establish a consumer network for product delivery

(71) Applicant: John Martins, Mclean, VA (US)

(72) Inventor: John Martins, Mclean, VA (US)

(21) Appl. No.: 15/593,777

(22) Filed: May 12, 2017

(51) Int. Cl. G06Q 10/08; G06Q 20/30

(52) U.S. Cl. CPC G06Q 10/083; G06Q 20/202; G06Q 20/30

(57) ABSTRACT

Techniques to improve the efficiency of online delivery of goods and services are described. In an example, technology and mass buying power may be used to connect and coordinate multiple individual consumers with different vendors of goods and services. Web based software that resides on an internet server may be used to facilitate online delivery of goods and services. The variables of delivery time and delivery location may be used to coordinate many individual orders for delivery by a vendor on a single trip to a single location during a specific time period. This vendor, time, and location coordination may have the effect of creating an ad-hoc network of consumers that may have similar delivery desires. The resulting delivery network may result in a large increase in delivery efficiency that may eliminate the vendor's need to charge delivery fees or require minimum orders.

### FIELD OF THE DISCLOSURE

The present invention is a system, method and apparatus for networking consumers in order to automate and coordinate the delivery of many individual consumer orders from a single vendor to geographically common locations at a single period in time.

### BACKGROUND

Vendors have been delivering goods directly to consumers for quite a while, and the origin can be traced to the beginning of civilization when individuals first began to trade goods and services. A good example is food delivery that has been performed since the first restaurants were established. Although delivery has been performed for thousands of years, methods to improve delivery continue to be invented. Delivery companies will deliver goods virtually anywhere in the world, however many merchants looking to sell their goods to local consumers in an on-demand fashion over short distances, still deliver their own products and services directly to the customer. Some notable examples are restaurant deliveries, newspaper deliveries, and landscaping services.

When vendors of food deliver their products directly to local customers, they tend to make individual trips to each consumer in a timely manner to preserve the perishable quality of food. Customer orders can be placed using different methods, including phone, fax, text messaging, and the Internet. When on-demand orders are received, vendors typically fill and deliver each order as quick as possible to minimize wait times. Occasionally when multiple individual orders are received during busy periods for delivery in geographically close locations, vendors can opportunistically combine multiple orders to deliver on a single trip, but this tends to be manual, haphazard, and still less than ideal.

In comparison, daily newspaper delivery is a mass delivery model that leverages a commitment to regularly scheduled deliveries to many consumers in efficient single trips. This construct, however, is constrained to situations where many variables remain constant including delivery times, locations, and a consistent consumer base.

A final service based example of delivery efficiency is a landscaping company that services multiple houses in the same neighborhood on the same day. Although efficient, this construct also is based upon a consumer subscription commitment to multiple transactions on a predictable periodic basis.

### SUMMARY

This invention improves online delivery by using web based software located at a URL on a server to network many single consumers according to product, vendor, time, and location to allow vendors to deliver multiple orders in a single trip. The result is a large increase in delivery efficiency. For example, if two consumer orders are combined into a single trip, this is a 100 percent increase in delivery efficiency. If more than 10 orders are combined, this is a 1000 percent increase in efficiency.

The invention allows the overhead cost associated with fuel, labor, and vehicle wear can be spread over multiple orders. As a result, vendors can eliminate the need to recoup costs by imposing minimum order amounts, charging delivery fees, or raising the cost of goods delivered. Other negative delivery impacts such as pollution and/or increased traffic congestion are also reduced by a similar percentage. During a two month beta testing period at a college, one vendor received 43 orders to be delivered on a single trip at a single time, resulting in an increased efficiency of over 4000 percent.

Continuing to examine the food delivery application, this invention will tend to expand the current delivery market beyond moderately priced food that feeds multiple people (like pizza or Chinese food), to theoretically any price point that includes cheap individual orders. For example, consumers are willing to pay $20 for a pizza delivery that feeds four people, but are more reluctant to pay $15 for delivery of a single serving sandwich. This invention's efficiency will allow vendors to eliminate the need to charge delivery fees for all price points, thus expanding the consumer base to those willing to pay the same price for goods to be delivered as they would at the store.

In summary, the purpose of this invention is to greatly increase the efficiency of the delivery of goods and services well beyond the current convenience and efficiency of online delivery. This invention creates a network of consumers with common delivery desires as they relate to vendor, time, and location. The resulting increase in efficiency creates an attractive and expanded market place for vendors of all goods and services.

### DESCRIPTION OF DRAWINGS

Although the characteristic features of this invention will be pointed out in the detailed description and claims, the invention itself, and the manner in which it may be made and used, may be better understood by referring to the following drawings, in which:

FIG. 1 is a simplified diagram depicting the components of the consumer delivery network;

FIG. 2 is a simplified diagram depicting the first delivery product logic decision for all modes of the invention.

FIG. 3 is a simplified diagram depicting the first of four mass delivery modes that use location and time to coordinate many deliveries and increase efficiency. Specifically, FIG. 3 depicts the logic and steps involved in the Single Location Vender Logic where the customer chooses the location, the vendor, and then the delivery time;

FIG. 4 is a simplified diagram depicting the second of four mass delivery modes that use location and time to coordinate many deliveries and increase efficiency. Specifically, FIG. 4 depicts the logic and steps involved in the Single Location Time Logic where the customer chooses the location, an approximate delivery time, and then the vendor;

FIG. 5 is a simplified diagram depicting the third of four mass delivery modes that use location and time to coordinate many deliveries and increase efficiency. Specifically, FIG. 5 depicts the logic and steps involved in the Single Vendor Logic where the customer chooses the vendor and then the delivery time. This mode can be used by a large name brand franchise chain as depicted for a single local restaurant to coordinate deliveries for a specific time;

FIG. 6 is a simplified diagram depicting the fourth mass delivery modes that use location and time to coordinate many deliveries and increase efficiency. Specifically, FIG. 6 depicts a future growth mode where the customer simply enters his location and desired delivery time and then chooses from a list of vendors that offer his desired delivery. This “on demand” mode will be available when sufficient numbers of customers order each day to allow many different delivery times throughout the day;

FIG. 7 is a simplified diagram depicting the steps in a common internet commerce payment process;

FIG. 8 is a simplified diagram depicting the steps involved in providing the vendor with detailed orders;

FIG. 9 is a simplified diagram depicting the steps in the vendor communication process;

### DETAILED DESCRIPTION OF THE INVENTION

This invention improves upon current online delivery of goods and services, and this description assumes a basic understanding of current tools used to accomplish local, national, and global delivery. Specifically, the construct where software resident on a internet server connects consumers with vendors by collecting order details and funds from consumers and providing them to a vendor. The vendor then arranges to deliver the goods or services. Thus, this description will focus on the invention's unique attributes that allow it to efficiently coordinate individual deliveries by vendor, location and time.

A vendor can accomplish delivery by using a separate delivery company or in the case of local customers, can complete the delivery themselves. This invention can benefit both local or long distance delivery. To consistently simplify the invention description, local online food delivery will be referenced most often as a primary use case example.

Overview: The invention creates a network of many customers to allow many orders to be delivered on a single trip by each vendor. This spreads the overhead delivery burden across multiple orders, greatly increasing the delivery efficiency. In the process, costs are reduced to an attractive level for both the consumer and the vendor. Mass delivery presents an opportunity for delivery of virtually any good or service by vendors directly to the consumer location, often avoiding the need to charge additional fees associated with the delivery service.

Applicability: This invention can be used to deliver a large variety of consumer products to include but not limited to prepared food from restaurants, groceries, pharmacy drugs, health care products, convenience store products, home improvement products, office supplies, clothing, or even department store goods. In addition, this invention can be used to deliver services directly to the consumer such as dry cleaning, hair styling, pet grooming, cleaning services, physician care, home repair, computer repair, and auto maintenance.

The Apparatus: The coordinating software and associated algorithms are located on an internet server that can be accessed by the consumers and vendors using any method currently available to access the internet. This includes mobile devices, with or without the assistance of mobile application software (Apps) created specifically for that purpose. The invention automates the entire process, including transmitting a variety of notifications via e-mail and text to all parties involved in the transaction.

The consumer facing software is designed to showcase and advertise the vendor's offerings and prices, and it has been optimized to facilitate many advertising techniques, including the use of special promotions and vendor placement on the site. In addition, a frequent consumer reward function has been built into the software to be tailored to individual vendors so they can reward repeated business from customers. The consumer facing function that is unique to this invention is the display of offerings as they apply to vendor, location and delivery times. This allows the invention algorithms to collate orders for vendors according to location and time.

The vendor facing software is designed to display orders for a single location at a single time, to print out those orders, and to facilitate the delivery process. The vendor facing software will allow customer notifications when orders have left the store, have arrived at the location, and to send special notes directly to the customers in case of late delivery or late pick-ups. The vendors also have access to data and statistics on previous orders. The promotion code functionality can also be used to incentivize future purchases and to credit a users account when the restaurant wants to compensate the consumer for previous customer dissatisfaction. The vendor facing function that is unique to this invention is the listing of customers and orders according to locations and delivery times. This allows vendors to prepare and delivery their goods and services in an efficient manner.

The administrator facing software is designed to modify both the consumer and vendor facing interface, analyze data, and to facilitate payments to vendors. Specifically, administrators can define and tailor key system parameters, add or delete vendors, and modify vendor offerings, prices, delivery times, loyalty program parameters, promotions, order cut off times, authorized users, passwords, and user account parameters. Furthermore, the administrative interface can be used to analyze most aspects of the invention and input different users, drivers, and store managers and can display performance results to various interested parties. The unique aspect of the administrator interface is to input data as it relates to vendors, locations and delivery times to allow the algorithms to process orders in an efficient fashion.

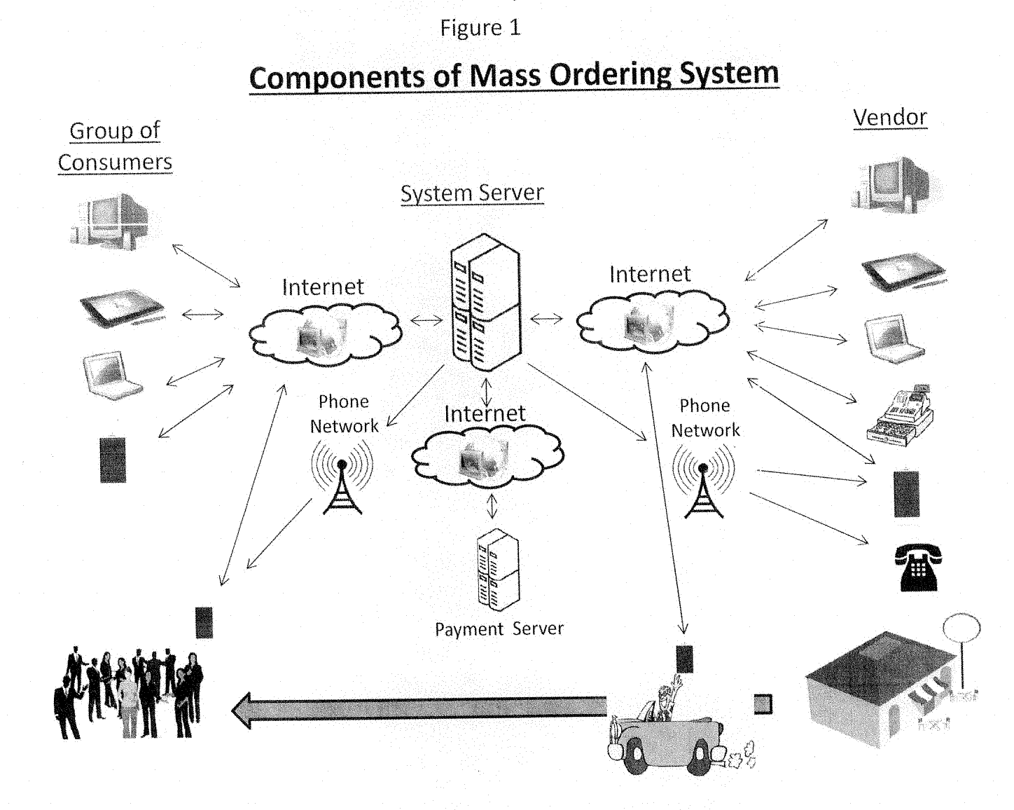

Components: Turning to the Figures and to FIG. 1 in particular, it depicts the system to network consumers to coordinate many orders from unrelated individuals to a single location at a single time. The term location in this context of delivery describes a geographically common area for potentially one or more drop offs in a single delivery trip. The phrase “at a single time” in this context of delivery describes a common period of time for potentially a series of drop offs in a single delivery trip. Delivered items can include many different types of goods and services, and are not restricted to commonly delivered items like food.

Thus, components of the invention include:
1. Devices for consumers, vendors, and administrators to access the internet.
2. The internet.
3. A server that is connected to the internet to display web pages and perform algorithms.
4. An internet payment provider to collect and disperse consumer money.
5. Software to display web pages, to perform algorithms to efficiently coordinate delivery, and to send messages in various forms to consumers, vendors, and administrators.
   In general, the components of the invention are common to most current on-line delivery processes.

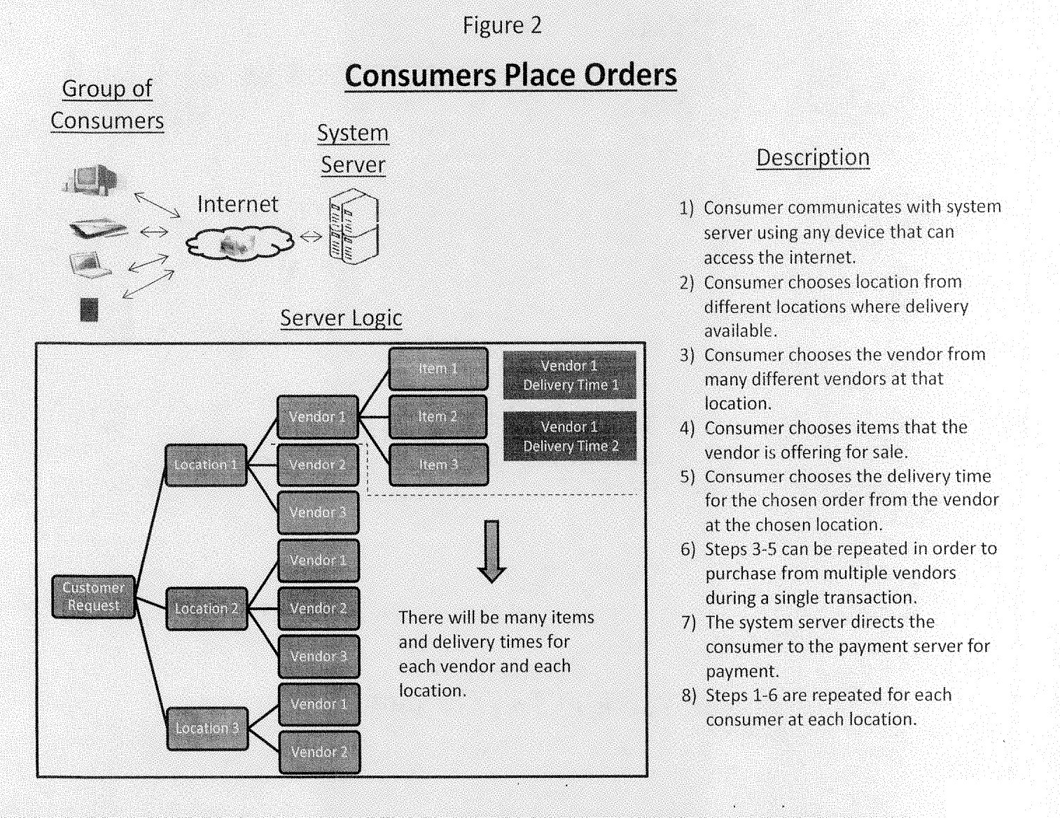

As this invention can be used to efficiently deliver many different types of goods and services, FIG. 2 depicts the first logic step involved in the invention. The customer accesses the invention server located at the site URL by logging on as either a guest or using a previously established account. The customer then chooses the desired category of delivery service to access the available delivery modes. Note, this step is not required when only one category of service is available to the customer. In these cases, the consumer is immediately directed to the ordering modes.

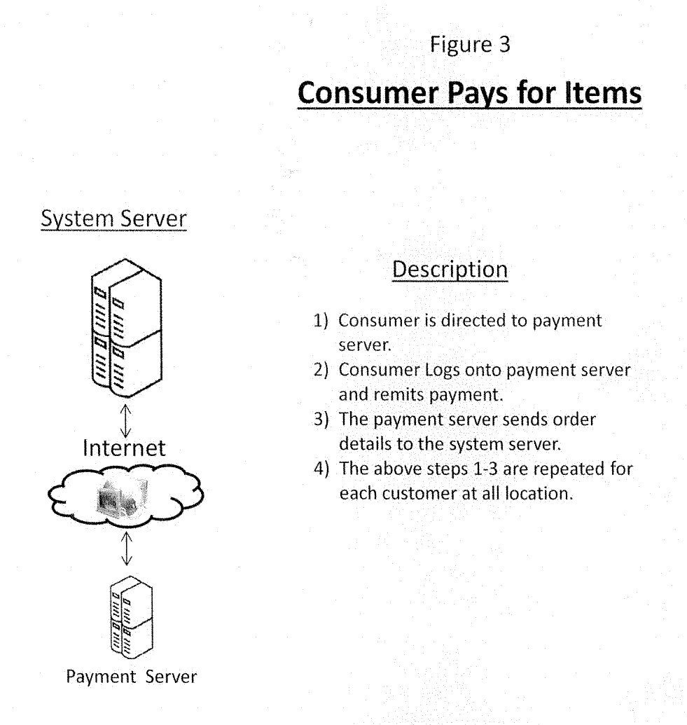

Delivery Mode 1—Choose Vendors then Time: FIG. 3 depicts the invention's primary delivery logic to coordinate delivery. First the consumer logs onto the server and enters his/her location. The location allows the software code to display vendors that delivery to that location as well as the drop off times that each vendor will delivery. The Consumer then selects the vendor and the software displays the goods and services that are available for delivery and the corresponding prices. Lastly, the consumer chooses the delivery time from a predetermined list of those available for that vendor on that day and pays for the goods. The system then collates and stores the selections into a database based upon delivery location, the vendor and delivery time. Lastly, the vendor then accesses the server to fulfill the orders for delivery to specific locations at a specific time.

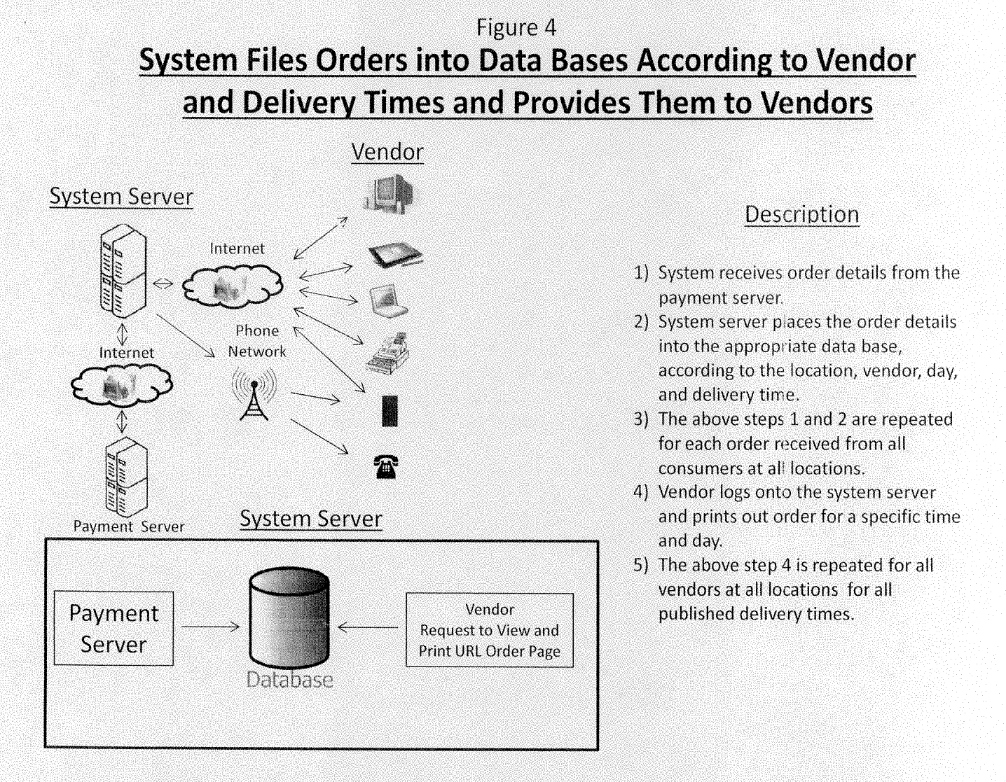

Delivery Mode 2—Choose Time then Vendor: FIG. 4 depicts the invention's alternate delivery logic to coordinate delivery. First the consumer logs onto the server and enters his/her location. The consumer then indicates his desired delivery time. The software displays the vendors that will deliver goods to that location within a predetermined period of the desired time (for example, 15 minutes). The Consumer then selects the vendor and the software displays the goods and services that are available for delivery with the corresponding prices. Lastly, the consumer confirms the delivery time from a list of those available for that vendor on that day and pays for the goods. The system then stores the selections into a database based upon the vendor and delivery time. Lastly, the vendor accesses the server to fulfill all orders for delivery at a single time.

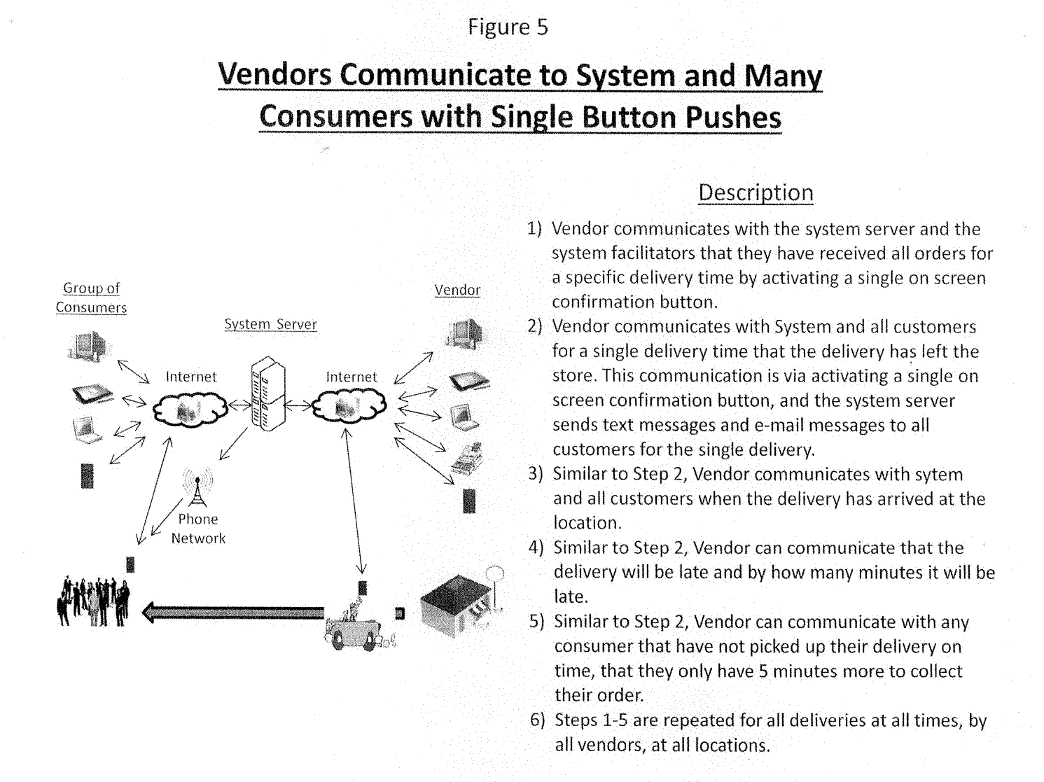

Delivery Mode 3—Solo Vendor Mode: FIG. 5 depicts the invention's ability to be tailored for a specific vendor, with the potential for the vendor to set up delivery of goods and services to locations not serviced by other vendors.

One applicable scenario is with franchises that have many different stores. In this case, the consumer begins by accessing the franchise's website, and the website directs the consumer to the invention's URL. At this point, the consumer enters his location, and a list of the available delivery times are displayed.

In the case of servicing multiple consumers at a single location, the algorithms function similarly to Delivery Modes 1 and 2 where individual consumer orders are collated into the data base according to delivery time.

Mode 3 also has a non-franchise application for single restaurants to be able to accomplish independent delivery operations. The restaurant will define the delivery area by either single locations with multiple consumers and/or consumers at different locations within a single delivery area. In both cases, the invention algorithm will perform as previously described for franchise scenarios.

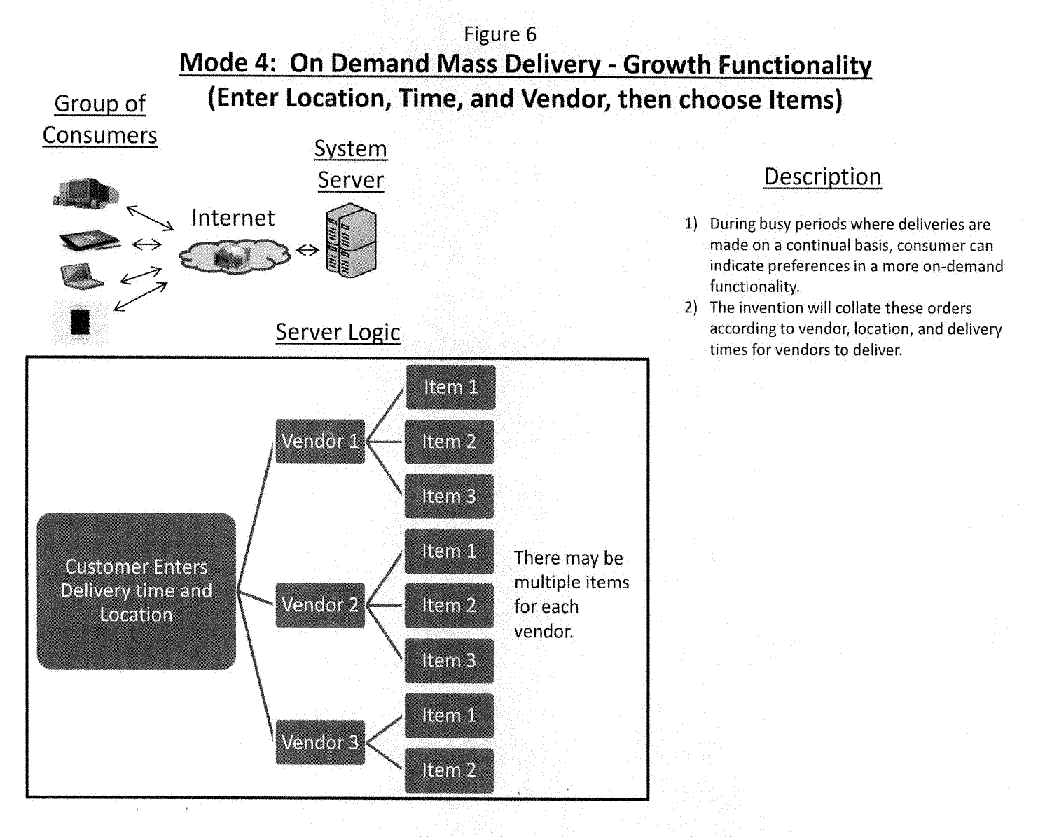

Delivery Mode 4—Flexible Delivery Times: FIG. 6 depicts the invention's most advanced functionality that allows the customer to enter a desired time that falls within a set time period instead of picking from a list of options. This allows an on demand function (compared to having to choose from a list of delivery times). The invention then collates delivery based upon time and location into the database and presents the orders to the vendors to prepare and deliver the orders in the most efficient fashion.

This delivery mode is only possible when sufficient number of customers are ordering during a time period to facilitate many delivery trips during a single day. It functions much like Mode 3, but services many more consumers on a continuous basis.

This mode can be applicable to franchises or individual vendors, as well as to many customers at a single location or at separate locations within a defined delivery area.

A General Note About Delivery Modes: Note in the description above, delivery Modes 3 and 4, use combinations of delivery Modes 1 and 2. The delivery modes listed above merely illustrate a small subset of the many ways the invention can automate and coordinate the delivery of many individual consumer orders from a single vendor to geographically common locations at a single period in time.

Completing the Time/Location Based Transaction and Delivery: FIG. 6 As depicted in FIG. 1, the invention components are similar to many internet commerce sites. The consumer can access the system server using any device that can access the internet to view the offerings from various vendors according to location. When the consumer is ready to purchase an item or service, he/she adds it to his or her cart for subsequent checkout. The unique aspect of the invention's ordering process is that except for Mode 4, the delivery time needs to be chosen by the consumer from a list of available options. Mode 4 differs from the first three because there is no constrained delivery times.

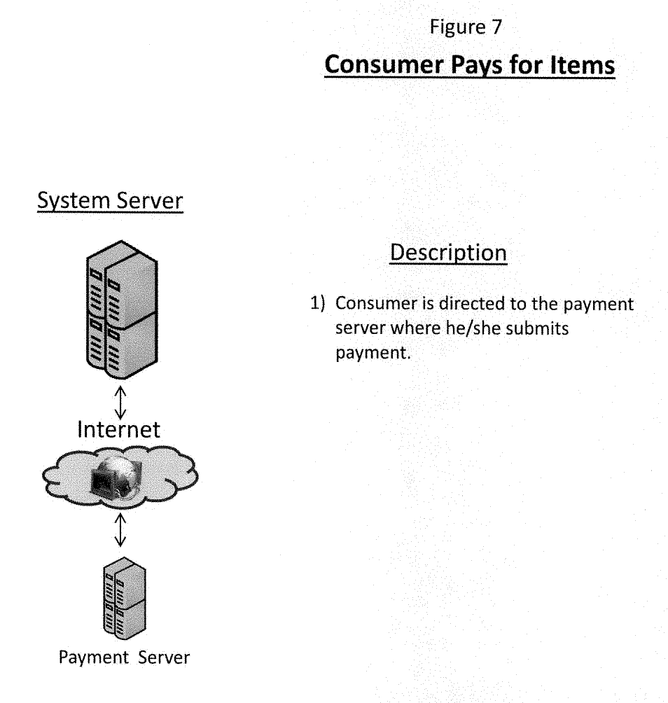

As depicted and described in FIG. 7, the consumer communicates with the system server that he/she is ready to pay, the system server redirects them to the payment server to complete the transaction. Upon completion of payment, the payment server provides the system server with the transaction details. The unique aspect of the invention's payment process is that the system server files the data in an appropriate file to be accessed by the vendor for mass delivery at the appropriate time.

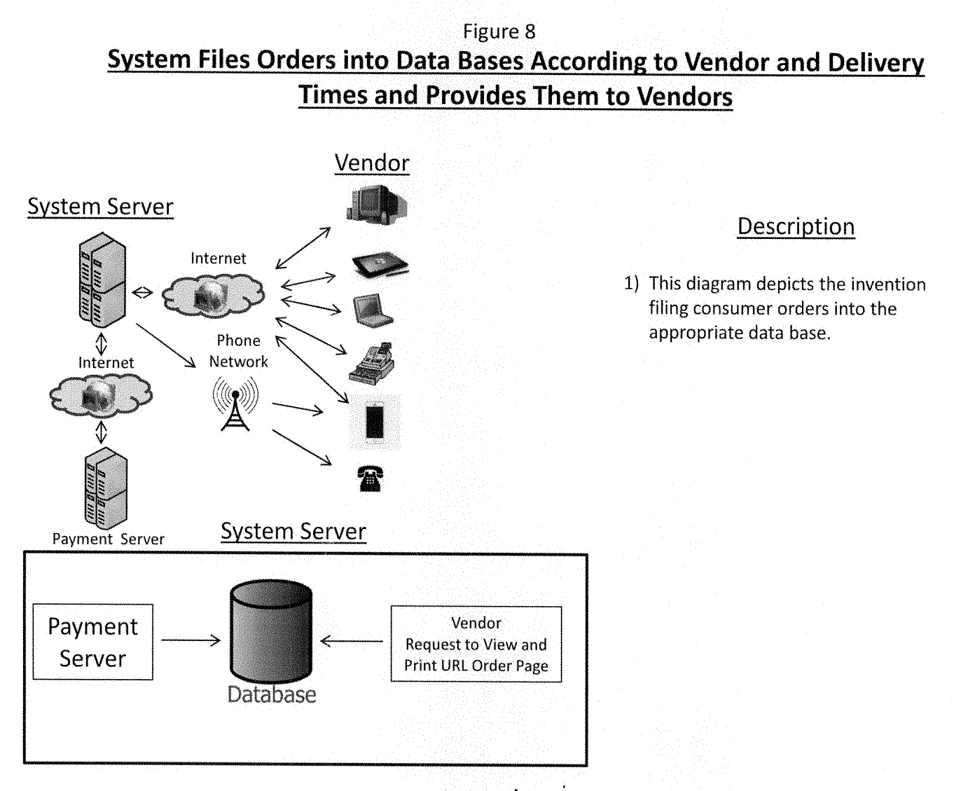

FIG. 8 depicts and describes this process, where the vendor can access the system server using any device that can access the internet.

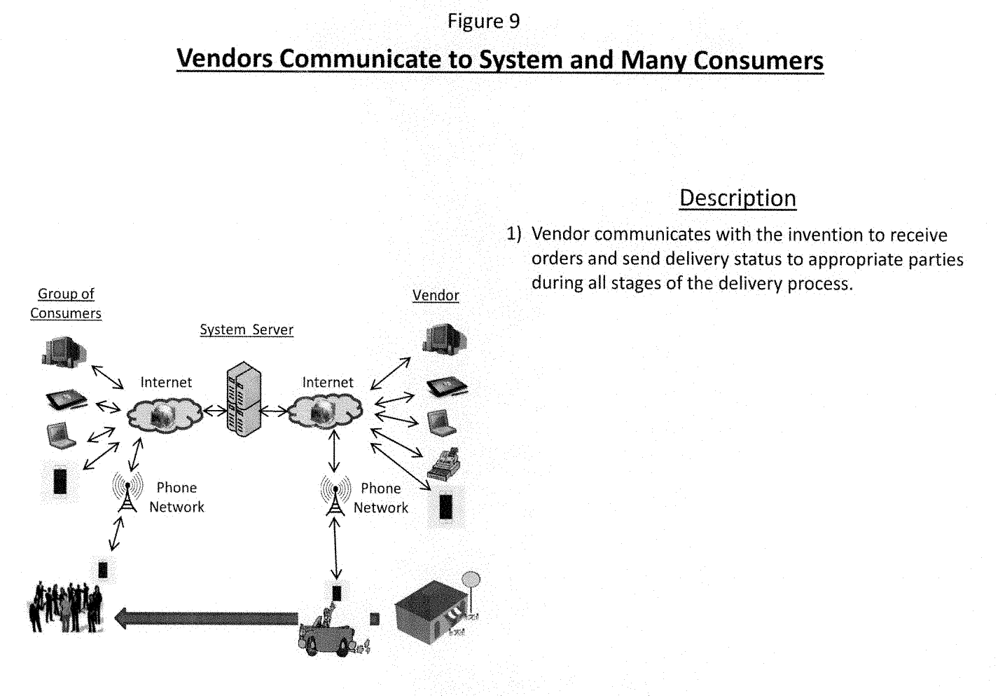

FIG. 9 depicts and describes the process where the vendor completes the transaction by preparing and delivering the goods or services. The vendor will electronically communicate that orders have been received, when the order leaves the store, and when the order arrives on location. The system will send notifications to customers, management, and the store during all phases of the transaction, as required via e-mail, text messages, and automated phone calls. The system is flexible to accommodate the specific communication capabilities and needs ranging from text messages, e-mails, and automated voice messaging.

### Additional Discussion Regarding Common Locations and Times

Deliverable locations are individually determined by the vendor and can be geographically defined single drop locations where many consumers are located such as an apartment building, or expanded areas that are determined by factors such as zip code or delivery distance/radius.

In the case of expanded areas where multiple consumers are at different locations in a common delivery area, the algorithms will first take orders according to a estimated delivery time. Then, the orders for a single delivery trip will be arranged according to maximum delivery efficiency using a mapping function. Finally, the orders will be collated into the database according to delivery drops, listed in order of most efficient delivery. The driver facing software has a mapping function that is automatically populated according to the multiple delivery locations. The software automatically tracks the driver location and sends updates to each customer. For a single delivery trip that services multiple locations, specific refined delivery times will be automatically sent to consumers once the cutoff time has passed and all orders are received. Although arranging and mapping multiple drop offs according to efficiency has been practiced arguably since the Post Office began at home delivery, a unique aspect of the invention is the ability to efficiently arrange and coordinate multiple drops at different locations on a single trip according to time and vendor.

Another unique aspect of the invention is the use of a cutoff time that is required to ensure on time preparation and delivery of orders. A cutoff time is the latest time that a consumer can place an order for listed delivery time. It is displayed in multiple pages by the consumer facing software. When the cutoff time is reached, the system is mechanized to accept no further orders for a specific delivery time, and the vendor is allowed access the orders to be printed out and executed.

When desired by the vendor, the invention can also be programmed to interface directly with the vendor's indigenous Point of Sales (POS) system to automatically populate the vendors system for item preparation and delivery. Orders are still placed and paid for using the invention's checkout and payment processes, but the orders can be filled and tracked via the retailer's system that is already in place.

Common Elements: In general, the unique and original aspects of the invention are the algorithms that connect multiple individual consumers to allow mass delivery coordination by vendor, time, and location. Thus, the 4 delivery mode examples, the ability to map and coordinate multiple drops on a single delivery, and the cutoff time feature emerge as the invention's distinguishing attributes from other common web-based delivery tools.

Some of the invention's features that are common to web-based commerce and delivery include:
Customer accounts.
A customer loyalty/rewards program.
A promotion code based award system that can offer percentage or dollar amount discounts.
Advertisement mechanisms on the site.
Website performance analytics/metrics.
Real time delivery tracking.
Automatic customer notifications.
Automatic vendor notifications.
Multiple payment options.
Corporate and social responsibility, with automatic donations to charity organizations.

The back-end interface of the system can define and tailor key system parameters, including different vendors, vendor offerings, offering prices, delivery times, loyalty program parameters, promotions, order cut off times, authorized users, passwords, and user account parameters.

Furthermore, the backend can be used to analyze performance for most aspects of the process and input different users, drivers, and managers of the vendors and can display the results to various interested parties.

The system also has a promotion function, where vendors or management can offer promotions to incentivize customers in multiple different ways including percentage off future orders or a quantified dollar value off future purchases. These promotions can be dispersed to individual users or whole groups of users depending on the desired consumer effect.

In addition, the system also has a built in customer loyalty program to further incentivize customers, as defined by individual restaurants. Parameters of the loyalty program can be varied using the back-end interface.

Invention Demonstration: Construction on the described invention began in February 2015, and was unveiled to the public when the website, www.mobdrop.delivery, went live in November 2015. Full functionality of Mode 1, described above, was demonstrated at the US Naval Academy when the first orders were successfully received, processed, and delivered on 21 Jan. 2016. The website functionality continued uninterrupted in a Beta test until 1 Apr. 2016. Operations at other locations are scheduled to resume in 2017.

Conclusion: Many additional modifications and variations of the present disclosure are possible in light of the above teachings. Thus, it is to be understood that, within the scope of the appended claims, the disclosure may be practiced otherwise than is specifically described above.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth.

What is claimed is:

1. An internet based delivery system for networking consumers according to vendor, time, and location to coordinate mass delivery of goods and services to multiple individual consumers on a single delivery trip. The invention algorithms use vendor, delivery time, and location to process many customer orders, and is comprised of:
a. Devices for consumers, vendors, and administrators to access the internet.
b. The internet.
c. A server that is connected to the internet to display web pages and perform algorithms.
d. An internet payment provider to collect and disperse consumer money.
e. Software and algorithms to display web pages, to perform algorithms to efficiently coordinate delivery, and to send messages in various forms to consumers, vendors, and administrators.

2. The system of claim 1 wherein the consumer facing software displays offerings as they apply to vendors, delivery location and times. The invention algorithms then collate and stores orders into a database according to vendor, location, and time.

3. The system of claim 1 wherein the vendor facing software displays a listing of customers and orders according to locations and delivery times. This allows vendors to prepare and delivery their goods and services with greater efficiency.

4. The system of claim 1 wherein the administrator facing software displays and facilitates input data as it relates to vendors, locations and delivery times to allow the algorithms to process orders in an efficient fashion.

5. The system of claim 1 that operates in multiple delivery modes to include a single or combination of the following modes, but not limited to:
a. Mode 1 that allows customers to choose location, vendor and goods, then delivery time before providing payment and completing the order.
b. Mode 2 that allows customers to choose location, time, and then the vendor and goods before providing payment and completing the order.
c. Mode 3 that allows customers to choose vendor, location, then delivery time before providing payment and completing the order.
d. Mode 4 that allows customers to choose the vendor, location, and then a desired delivery time (not being constrained by a list of time options).

6. The system of claim 1 that automatically coordinates consumer orders for multiple drops at different locations in a single geographical area on a single trip, and arranges the drops based upon the most efficient delivery route.

7. The system of claim 1 that uses a cutoff time for the system to stop accepting and processing orders for a single vendor for delivery to a location at a specific time. This cutoff time can be modified as required by each vendor and is used by the algorithms for multiple functions, including vendor notification and allowing access orders to be printed out and executed.
